(19) United States
(12) Patent Application Publication
(10) Pub. No.: US 2026/0288144 A1
(43) Pub. Date: Sep. 24, 2026

(54) NON-PRECISION MAP-BASED DRIVING GUIDE APPARATUS, METHOD, AND SYSTEM

(71) Applicants: Hyundai Motor Company, Seoul (KR); Kia Corporation, Seoul (KR)

(72) Inventors: Kyungzun Rim, Hwaseong-si (KR); Jaeoh Lee, Hwaseong-si (KR); Chung Hyuk Kang, Hwaseong-si (KR)

(21) Appl. No.: 19/298,053

(22) Filed: Aug. 12, 2025

(30) Foreign Application Priority Data
Mar. 24, 2025 (KR) 10-2025-0037258

(51) Int. Cl. G05D 1/246; G05D 1/229; G05D 1/248; G05D 1/644; G05D 107/13; G05D 109/10; G05D 111/10; G05D 111/50

(52) U.S. Cl. CPC G05D 1/2469; G05D 1/229; G05D 1/248; G05D 1/644; G05D 2107/13; G05D 2109/10; G05D 2111/17; G05D 2111/52

(57) ABSTRACT

A non-precision map-based driving guide method performed by a computing device including a processor and a memory according to an exemplary embodiment may include determining, by the processor, a first position estimated as a current position of a robot on a non-precision map based on at least one of global positioning system (GPS) information and inertial measurement unit (IMU) information, determining, by the processor, a second position by projecting the first position onto an adjacent drivable area using the GPS information, and determining, by the processor, the second position as a way point for the first position.

### CROSS-REFERENCE TO RELATED APPLICATIONS

This application claims priority to and the benefit of Korean Patent Application No. 10-2025-0037258 filed with the Korean Intellectual Property Office on Mar. 24, 2025, the entire contents of which are incorporated herein by reference.

### TECHNICAL FIELD

The present disclosure relates to a non-precision map-based driving guide apparatus, method, and system, and more particularly, to a non-precision map-based driving guide apparatus, method, and system for a person or a robot to drive using only GPS and sensor information without creating a precision map in an outdoor service field.

### BACKGROUND

The related art creates a precise map using images or Light Detection and Ranging (LiDAR), finds a position and a path through the precise map. Since the related art requires a lot of cost to create the precise map, it costs a lot to create a map of a new space.

To overcome the problems of the related art, a method is needed to enable a robot to drive using only simple non-precision map and current sensor information.

### SUMMARY

The present disclosure attempts to provide a non-precision map-based driving guide apparatus, method, and system capable of estimating a current position of a robot based on GPS information and determining a way point to a destination based on a non-precision map, which is a simplified map, instead of a precision map.

According to an exemplary embodiment of the present disclosure, there is provided a non-precision map-based driving guide apparatus that estimates a current position based on GPS information on a non-precision map without creating a precision map and determines a way point to a destination by executing a program code loaded on one or more memory devices through one or more processors, in which the program code is executed to perform: determining a first position estimated as a current position of a robot on the non-precision map based on at least one of global positioning system (GPS) information and inertial measurement unit (IMU) information, determining a second position by projecting the first position onto an adjacent drivable area using the GPS information, and determining the second position as the way point for the first position.

The determining of the second position as the way point for the first position may include determining a plurality of way points to the destination based on the first position and the second position, respectively.

The determining of the first position estimated as the current position of the robot on the non-precision map based on at least one of the global positioning system (GPS) information and the inertial measurement unit (IMU) information may include determining the first position using an open street map (OSM) as the non-precision map.

The determining of the second position by projecting the first position onto the adjacent drivable area using the GPS information may include determining at least one drivable area that is less than a reference distance from the first position among a plurality of drivable areas on the non-precision map as the adjacent drivable area.

The determining of the second position by projecting the first position onto the adjacent drivable area using the GPS information may further include, when there are a plurality of determined adjacent drivable areas, calculating respective similarities with GPS-based past positions determined before the first position with respect to each of the first candidate path and the second candidate path defined in each of the plurality of adjacent drivable areas, determining one of the first candidate path or the second candidate path as a final path based on the calculated similarity, and determining the second position by projecting the first position onto the determined final path.

The calculating of the respective similarities with the GPS-based past positions determined before the first position with respect to each of the first candidate path and the second candidate path defined in each of the plurality of adjacent drivable areas may include calculating a path cost of each of the first candidate path and the second candidate path using Equation 1,

$$cost ( path ) = {\sum }_{t = 1} {d}_{t} \qquad [ equation l ]$$

Here, cost (path) may be a path cost of the candidate path, dₜ may be a path cost of a partial path on the candidate path at time t, and a partial path may correspond to each of the plurality of sections on the candidate path.

The calculating of the respective similarities with GPS-based past positions determined before the first position with respect to each of the first candidate position on the first candidate path and the second candidate position on the second candidate path defined in each of the plurality of adjacent drivable areas may further include calculating partial path cost of each of the partial paths at time t using Equation 2,

$${d}_{t} = \vert {‖ {P}_{t - 1} - {P}_{t} ‖}_{2} - {‖ {C}_{t - 1 , i} - {C}_{t , j} ‖}_{route} \vert - \vert cos ( Δ {θ}_{t} ) \vert \qquad [ equation 2 ]$$

$${Δθ}_{t} = {θ}_{t} - {θ}_{t , j}$$

Here, t is time, dₜ is the path cost of the partial path at time t, Pₜ is the estimated robot position at time t, C_{t,j} is the position of Pₜ projected onto an i-th drivable area, Δθₜ=θₜ−θ_{t,j} is an angular difference between an angle of the path and the robot position at time t, θₜ is an angle of P̅ₜ̅P̅ₜ̅₊̅₁̅ base on a true north, θ_{t,j} is an angle of an edge at C_{t,j} based on the true north, ∥C_{t-1,i}−C_{t,j}∥ᵣₒᵤₜₑ is a distance along the path, and ∥Pₜ₋₁−Pₜ∥₂ is a Euclidean distance.

The determining of one of the first candidate path or the second candidate path as the final path based on the similarity may include determining a candidate path with a smaller path cost among the first candidate path and the second candidate path as the final path.

According to another exemplary embodiment of the present disclosure, a non-precision map-based driving guide method performed by a computing device including a processor and a memory includes: determining, by the processor, a first position estimated as a current position of a robot on a non-precision map based on at least one of global positioning system (GPS) information and inertial measurement unit (IMU) information; determining, by the processor, a second position by projecting the first position onto an adjacent drivable area using the GPS information; and determining, by the processor, the second position as a way point for the first position.

The determining of the second position as the way point for the first position may include determining, by the processor, a plurality of way points to a destination based on the first position and the second position, respectively.

The determining of the first position estimated as the current position of the robot on the non-precision map based on at least one of the global positioning system (GPS) information and the inertial measurement unit (IMU) information may include determining, by the processor, the first position using an open street map (OSM) as the non-precision map.

The determining of the second position by projecting the first position onto the adjacent drivable area using the GPS information may include determining, by the processor, at least one drivable area that is less than a reference distance from the first position among a plurality of drivable areas on the non-precision map as the adjacent drivable area.

The determining of the second position by projecting the first position onto the adjacent drivable area using the GPS information may further include: when there are a plurality of determined adjacent drivable areas, calculating, by the processor, respective similarities with GPS-based past positions determined before the first position with respect to each of the first candidate path and the second candidate path defined in each of the plurality of adjacent drivable areas; determining, by the processor, one of the first candidate path or the second candidate path as a final path based on the calculated similarity; and determining, by the processor, the second position by projecting the first position onto the determined final path.

The calculating of the respective similarities with the GPS-based past positions determined before the first position with respect to each of the first candidate path and the second candidate path defined in each of the plurality of adjacent drivable areas may include calculating by the processor, a path cost of each of the first candidate path and the second candidate path using Equation 1,

$$cost ( path ) = {\sum }_{t = 1} {d}_{t} \qquad [ equation 1 ]$$

Here, cost (path) may be a path cost of the candidate path, dₜ may be a path cost of a partial path on the candidate path at time t, and a partial path may correspond to each of the plurality of sections on the candidate path.

The calculating of the respective similarities with the GPS-based past positions determined before the first position with respect to each of the first candidate path and the second candidate path defined in each of the plurality of adjacent drivable areas may further include calculating, by the processor, partial path cost of each of the partial paths at time t using Equation 2,

$${d}_{t} = \vert {‖ {P}_{t - 1} - {P}_{t} ‖}_{2} - {‖ {C}_{t - 1 , i} - {C}_{t , j} ‖}_{route} \vert - \vert cos ( Δ {θ}_{t} ) \vert \qquad [ Equation 2 ]$$

$${Δθ}_{t} = {θ}_{t} - {θ}_{t , j}$$

Here, t is time, dₜ is the path cost of the partial path at time t, Pₜ is the estimated robot position at time t, C_{t,j} is the position of Pₜ projected onto an i-th drivable area, Δθₜ=θₜ−θ_{t,j} is an angular difference between an angle of the path and the robot position at time t, θₜ is an angle of P̅ₜ̅P̅ₜ̅₊̅₁̅ base on a true north, θ_{t,j} is an angle of an edge at C_{t,j} based on the true north, ∥C_{t-1,i}−C_{t,j}∥ᵣₒᵤₜₑ is a distance along the path, and ∥Pₜ₋₁−Pₜ∥₂ is a Euclidean distance.

The determining of one of the first candidate path or the second candidate path as the final path based on the similarity may include determining, by the processor, a candidate path with a smaller path cost among the first candidate path and the second candidate path as the final path.

According to still another exemplary embodiment of the present disclosure, a non-precision map-based driving guide system includes: a sensor unit that includes GPS, LiDAR, and a plurality of cameras; a driving guide unit that receives a non-precision map, estimates a current position of a robot on a non-precision map based on sensor information received from the sensor unit, determines a way point to a destination, and generates a driving path plan based on the way point; and a robot control unit that controls the driving of the robot based on the driving path plan received from the driving guide unit.

The driving guide unit may include: a non-precision map-based driving guide apparatus that estimates a current position of the robot based on GPS information on the non-precision map and determines the way point to the destination; a drivable area detection apparatus that detects an area in which the robot drives and an area in which the robot does not drive, respectively, using the sensor information; and a local goal determination apparatus that determines a short-term driving path among the driving path plans from the current position to the destination as a local goal based on information on the current position, the way point, and the drivable area.

The non-precision map-based driving guide apparatus may include: a first position determination module that determines a first position estimated as a current position of a robot on the non-precision map based on at least one of global positioning system (GPS) information and inertial measurement unit (IMU) information, and a second position determination module that determines a second position by projecting the first position onto an adjacent drivable area using the GPS information, and a way point determination module that determines the second position as the way point for the first position.

The second position determination module may, when there are a plurality of determined adjacent drivable areas, calculate respective similarities with past positions determined before the first position with respect to each of the first candidate path and the second candidate path defined in each of the plurality of adjacent drivable areas, determine one of the first candidate path or the second candidate path as a final path based on the calculated similarity, and determine the second position by projecting the first position onto the determined final path.

According to the non-precision map-based driving guide apparatus, method, and system according to an exemplary embodiment of the present disclosure, it is possible to estimate the current position of the robot based on the GPS information without creating the precision map and determine the way point to the destination.

According to the non-precision map-based driving guide apparatus, method, and system according to an exemplary embodiment of the present disclosure, it is possible to minimize the time and cost because they use only the non-precision map without the precision map.

According to the non-precision map-based driving guide apparatus, method, and system according to an exemplary embodiment of the present disclosure, the maintenance frequency is low and the remote response is possible because they use the non-precision map.

### BRIEF DESCRIPTION OF THE DRAWINGS

FIG. 1 is a block diagram of a non-precision map-based driving guide system according to an embodiment of the present disclosure.

FIG. 2 is a block diagram of the non-precision map-based driving guide apparatus according to an embodiment of the present disclosure.

FIGS. 3 to 5 are flowcharts of a non-precision map-based driving guide method according to an embodiment of the present disclosure.

FIG. 6 is a diagram illustrating a generated current position and driving guidance including a way point, acquired according to an embodiment of the present disclosure.

FIG. 7 is a diagram illustrating a candidate path according to an embodiment of the present disclosure.

FIGS. 8A and 8B are diagrams for describing a method for calculating a path cost of each of candidate paths according to an exemplary embodiment of the present disclosure.

FIG. 9 is a diagram for describing a computing device according to an exemplary embodiment of the present disclosure.

### DETAILED DESCRIPTION OF ILLUSTRATIVE EMBODIMENTS

Hereinafter, exemplary embodiments of the present disclosure will be described more fully with reference to the accompanying drawings so as to be easily practiced by those skilled in the art to which the present disclosure pertains. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising”, will be understood to imply the inclusion of stated elements but not the exclusion of any other elements. Terms including an ordinal number such as first, second, etc., may be used to describe various components, but the components are not limited to these terms. The above terms are used solely for the purpose of distinguishing one component from another.

Terms such as “ . . . unit”, “ . . . er/or”, and “module” used in the specification may mean a unit capable of processing at least one function or operation described in the specification, which may be implemented as hardware or a circuit, software, or a combination of hardware or circuit and software.

In addition, at least some components or functions of a non-precision map-based driving guide apparatus, method, and system according to the exemplary embodiments to be described below may be implemented as a program or software, and the program or software may be stored on a computer-readable medium.

Hereinafter, exemplary embodiments of the present disclosure will be described with reference to the drawings.

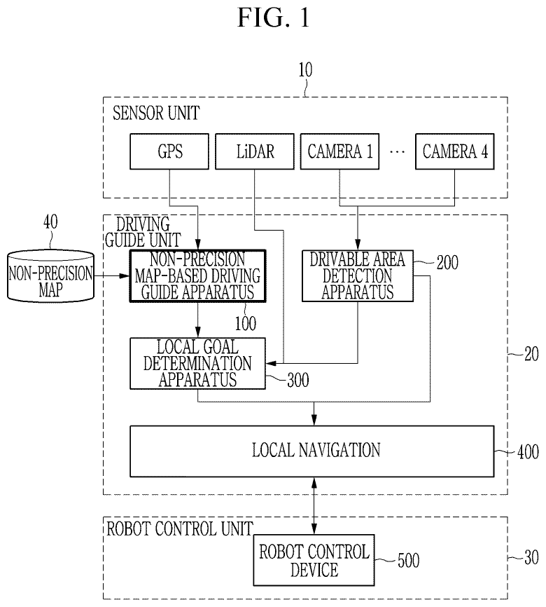

FIG. 1 is a block diagram of a non-precision map-based driving guide system according to an embodiment of the present disclosure.

Referring to FIG. 1, a non-precision map-based driving guide system may include a sensor unit 10, a driving guide unit 20, and a robot control unit 30.

The non-precision map-based driving guide system may collect information necessary for driving of a robot from a sensor, etc., establish driving path planning using the collected information, and control the driving of the robot using the established driving path plan.

The non-precision map-based driving guide system is a system that uses a non-precision map, such as an open street map (OSM) which is a simple map, instead of a precision map, to find a way point to a destination, and selects a local goal from the current robot standard and drives to reach a final destination based on the found way point.

The sensor unit 10 may include GPS, LiDAR, and multiple cameras.

The GPS, the LiDAR, and the plurality of cameras may provide sensor information including the GPS information.

The driving guide unit 10 receives a non-precision map 40.

The non-precision map 40 is a general GPS-based map and may include only information on roads and major geometry features. The non-precision map 40 provides information on roads and major geometry features with accuracy in units of meters. On the other hand, the precision map is expressed in units of centimeters (cm) and may include detailed information such as road structures, lanes, signals, and signs.

For example, the non-precision map 40 may include Google Map or an open street map (OSM).

The OSM is a representative non-precision map and is an open source map project that provides free global geographic information. The OSM allows editing and use of user data.

The driving guide unit 10 may estimate the current position of the robot on the non-precision map 40 based on the sensor information received from the sensor unit 10, determine the way point to the destination, and generate the driving path plan based on the way point.

The driving guide unit 20 may include a non-precision map-based driving guide apparatus 100, a driving area detection apparatus 200, a local goal determination apparatus 300, and a local navigation 400.

The non-precision map-based driving guide apparatus 100 may estimate the current position of the robot on the non-precision map based on the GPS information and determine the way point to the destination.

The way point may mean a specific coordinate or position set as an intermediate stopover on a moving path. The way point may be used by a robot, a vehicle, a drone, or a game character to follow a path to a target point.

The non-precision map-based driving guide apparatus 100 may receive GPS information and/or IMU information to detect the approximate current position of the robot from the non-precision map.

The non-precision map-based driving guide apparatus 100 may project the current position based on the GPS information onto the drivable area on the non-precision map.

When there are multiple areas where projection is possible around the current position, it is impossible to find the exact way point if the way points are found using only the GPS information with an average error of 5 m.

Therefore, the non-precision map-based driving guide apparatus 100 selects one of multiple projectable areas and projects the current position using the similarity between the previously estimated robot trajectory and the way point in order to resolve the error from the GPS information.

The non-precision map-based driving guide apparatus 100 may calculate multiple way points to a destination based on a projected position and transmit the calculated way points to the local goal determination apparatus 300.

The drivable area detection apparatus 200 may detect the areas in which the robot may drive and areas in which the robot may not drive on the non-precision map 40 using the sensor information.

The local goal determination apparatus 300 may determine a local goal. The local goal may mean a target point to which the robot or vehicle should immediately move based on the way point.

The local goal may be a target point that is updated in real time by reflecting sensor data (obstacle detection, road information, etc.) in autonomous driving or robot navigation.

In other words, the local goal is a target point in a smaller unit than the way point, and may be adjusted in real time according to obstacles or environmental changes.

The local goal determination apparatus 300 may determine a short-term driving path from the current position to the destination as the local goal for the driving path plan of the robot based on information about the current position of the robot, the way point, and drivable area.

The local navigation 400 may receive the local goal from the local goal determination apparatus 300 and generate the driving path or the driving path plan based on the local goal.

The robot control unit 30 includes a robot control device 500.

The robot control device 500 may control the driving of the robot based on the driving path plan received from the driving guide unit 20.

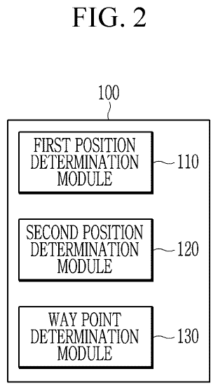

FIG. 2 is a block diagram of a non-precision map-based driving guide apparatus (e.g., the non-precision map-based driving guide apparatus 100 shown in FIG. 1 and discussed above) according to an embodiment of the present disclosure.

The non-precision map-based driving guide apparatus 100 according to an exemplary embodiment may execute program codes or instructions loaded in one or more memory devices through one or more processors. As an example, the one or more memory devices may be one of more non-transitory computer readable mediums strong instructions that, when executed by the one or more processors, cause the one or more processors to perform operations in accordance with embodiments disclosed herein.

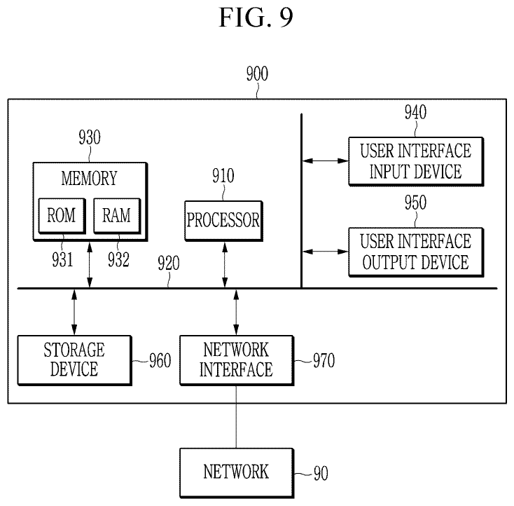

For example, the non-precision map-based driving guide apparatus 100 may be implemented as a computing device 900 as described below with reference to FIG. 9. In this case, one or more processors may correspond to a processor 910 of the computing device 900, and one or more memory devices may correspond to a memory 930 of the computing device 900.

The program code or instructions may be executed by one or more processors to estimate the current position of the robot based on the GPS information without creating the precise map and determine the way point to the destination. In this specification, the term “module” is used to logically distinguish these functions performed by the program code or instructions.

Referring to FIG. 2, the non-precision map-based driving guide apparatus 100 may include a first position determination module 110, a second position determination module 120, and a way point determination module 130.

The first position determination module 110 may determine a first position estimated as the current position of the robot on the non-precision map based on at least one of the global positioning system (GPS) information and the inertial measurement unit (IMU) information.

The first position determination module 110 may determine the first position using the open street map (OSM) as the non-precision map.

The second position determination module 120 may determine a second position by projecting the first position to an adjacent drivable area using the GPS information.

The second position determination module 120 may determine at least one drivable area that is less than a reference distance from the first position among a plurality of drivable areas on the non-precision map as an adjacent drivable area.

The adjacent drivable area may be an area on which the first position may be projected among the drivable areas.

The second position determination module 120 may select one adjacent drivable area from among the plurality of adjacent drivable areas based on the similarity between the past estimated positions of candidate paths defined in each of the plurality of adjacent drivable areas when there are multiple determined adjacent drivable areas.

The second position determination module 120 may calculate the similarity between the first candidate position on a first candidate path and the second candidate position on a second candidate path and the past position based on GPS determined before the first position, respectively.

The first candidate path may be defined in the first adjacent drivable area, and the second candidate path may be defined in the second adjacent drivable area.

The second position determination module 120 may determine one of the first candidate path or the second candidate path as the final path based on the calculated similarity.

The second position determination module 120 may determine the second position by projecting the first position onto the determined final path.

The second position determination module 120 may calculate the path cost of each of the first candidate path and the second candidate path using Equation 1. The path cost may be inversely proportional to the similarity.

$$cost ( path ) = {\sum }_{t = 1} {d}_{t} \qquad [ Equation 1 ]$$

Here, cost (path) may be a path cost of the candidate path, dₜ may be a path cost of a partial path on the candidate path at time t, and a partial path may correspond to each of the plurality of sections on the candidate path.

The path cost of the candidate path may be determined as the sum of the path costs of the multiple partial paths.

The second position determination module 120 may calculate the position cost of the candidate position at time t using Equation 2.

$${d}_{t} = \vert {‖ {P}_{t - 1} - {P}_{t} ‖}_{2} - {‖ {C}_{t - 1 , i} - {C}_{t , j} ‖}_{route} \vert - \vert cos ( Δ {θ}_{t} ) \vert \qquad [ Equation 2 ]$$

$${Δθ}_{t} = {θ}_{t} - {θ}_{t , j}$$

Here, t may be time, dₜ may be the path cost of the partial path at time t, Pₜ may be the estimated robot position at time t, C_{t,j} may be the position of Pₜ projected onto an i-th drivable area, Δθₜ=θₜ−θ_{t,j} may be an angular difference between an angle of the path and the robot position at time t, θₜ may be an angle of P̅ₜ̅P̅ₜ̅₊̅₁̅ base on a true north, θ_{t,j} may be an angle of an edge at C_{t,j} based on the true north, ∥C_{t-1,i}−C_{t,j}∥ᵣₒᵤₜₑ may be a distance along the path, and ∥Pₜ₋₁−Pₜ∥₂ may be a Euclidean distance.

The second position determination module 120 may determine a candidate path with a smaller path cost among the first candidate path and the second candidate path as the final path.

The way point determination module 130 may determine the second position projected onto the final path as the way point for the first position or the current position.

The way point determination module 130 may determine a plurality of way points to the destination by repeatedly determining the final path based on the current position and determining the second position projected onto the final path.

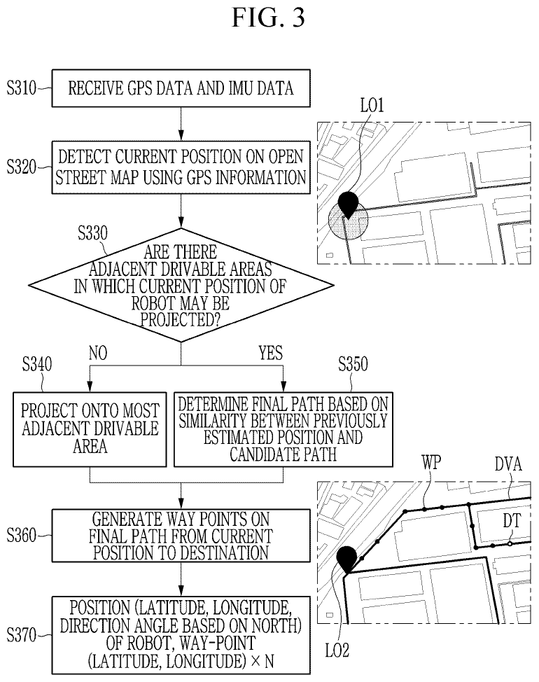

FIGS. 3 to 5 are flowcharts of a non-precision map-based driving guide method according to an embodiment of the present disclosure. The non-precision map-based driving guide method may be performed through the non-precision map-based driving guide apparatus 100 of FIG. 2.

In FIG. 3, the non-precision map-based driving guide apparatus 100 may receive the global positioning system (GPS) data and the inertial measurement unit (IMU) data (step S310).

The non-precision map-based driving guide apparatus 100 may receive information about the drivable area (DVA) from the drivable area detection apparatus 200.

The non-precision map-based driving guide apparatus 100 may detect the current position from the open street map (OSM) using the GPS information and/or the IMU information (step S320).

The non-precision map-based driving guide apparatus 100 may determine a first position LO1 estimated as the current position of the robot on the non-precision map based on at least one of the GPS information and the IMU information.

The non-precision map-based driving guide apparatus 100 may determine a second position LO2 by projecting the first position LO1 to the drivable area DVA using the GPS information.

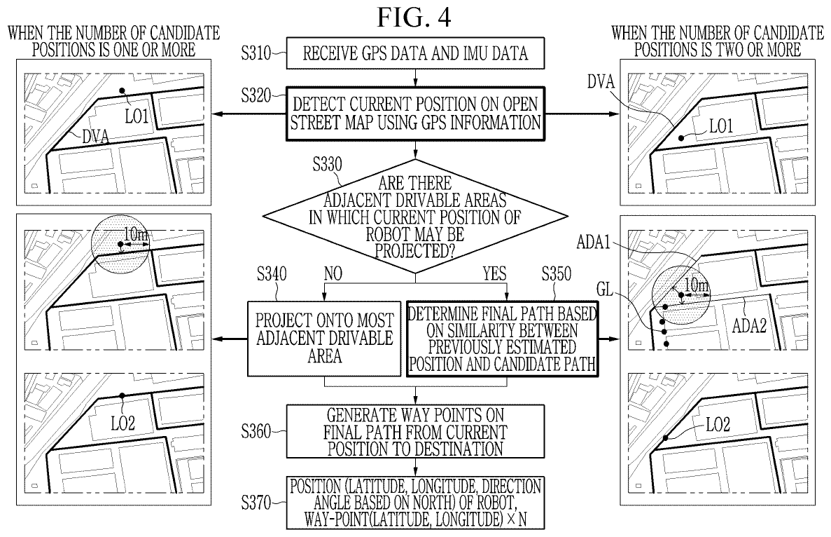

In FIG. 4, the non-precision map-based driving guide apparatus 100 may determine whether there are multiple adjacent drivable areas ADA to which the first position LO1, which is the current position of the robot, may be projected among the drivable areas DVA (step S330).

The non-precision map-based driving guide apparatus 100 may determine at least one drivable area that is less than a reference distance from the first position LO1 among the multiple drivable areas DVA on the non-precision map as the adjacent drivable area ADA.

The non-precision map-based driving guide apparatus 100 may project the first position LO1 to the nearest adjacent drivable area ADA when there are not multiple adjacent drivable areas ADA (step S340).

The non-precision map-based driving guide apparatus 100 may determine the second position LO2 by projecting the first position LO1 to the nearest adjacent drivable area ADA within 10 meters.

The non-precision map-based driving guide apparatus 100 may determine the final path based on the similarity between the previously estimated position and the candidate path when there are multiple adjacent drivable areas ADA (step S350).

The non-precision map-based driving guide apparatus 100 may determine a path passing through a first adjacent drivable area ADA1 as a first candidate path, and a path passing through a second adjacent drivable area ADA2 as the second candidate path.

The non-precision map-based driving guide apparatus 100 may determine one of the first and second candidate paths as the final path based on the similarity between the previously estimated robot positions GL based on the GPS and the first and second candidate paths.

Here, the similarity may be inversely proportional to the path cost. That is, the smaller the path cost, the greater the similarity between the candidate path and the previously estimated robot position GL.

The non-precision map-based driving guide apparatus 100 may determine the candidate path with the highest similarity as the final path.

For example, the similarity between the first candidate position on the first candidate path defined in the first adjacent drivable area ADA1 and the second candidate position on the second candidate path defined in the second adjacent drivable area ADA2 and the GPS-based past position GL determined before the first position may be calculated, respectively.

The non-precision map-based driving guide apparatus 100 may calculate the path cost of each of the first candidate path and the second candidate path using Equation 1.

$$cost ( path ) = {\sum }_{t = 1} {d}_{t} \qquad [ Equation 1 ]$$

Here, cost (path) is a path cost of the candidate path, dt is a path cost of a partial path on the candidate path at time t, and a partial path corresponds to each of the plurality of sections on the candidate path.

The non-precision map-based driving guide apparatus 100 may calculate the position cost of the candidate position at time t using Equation 2.

$${d}_{t} = \vert {‖ {P}_{t - 1} - {P}_{t} ‖}_{2} - {‖ {C}_{t - 1 , i} - {C}_{t , j} ‖}_{route} \vert - \vert cos ( Δ {θ}_{t} ) \vert \qquad [ Equation 2 ]$$

$${Δθ}_{t} = {θ}_{t} - {θ}_{t , j}$$

Here, t may be time, dₜ may be the path cost of the partial path at time t, Pₜ may be the estimated robot position at time t, C_{t,j} may be the position of Pₜ projected onto an i-th drivable area, Δθₜ=θₜ−θ_{t,j} may be an angular difference between an angle of the path and the robot position at time t, θₜ may be an angle of P̅ₜ̅P̅ₜ̅₊̅₁̅ base on a true north, θ_{t,j} may be an angle of an edge at C_{t,j} based on the true north, ∥C_{t-1,i}−C_{t,j}∥ᵣₒᵤₜₑ may be a distance along the path, and ∥Pₜ₋₁−Pₜ∥₂ may be a Euclidean distance.

The non-precision map-based driving guide apparatus 100 may determine the second position LO2 by projecting the first position LO1 onto the determined final path.

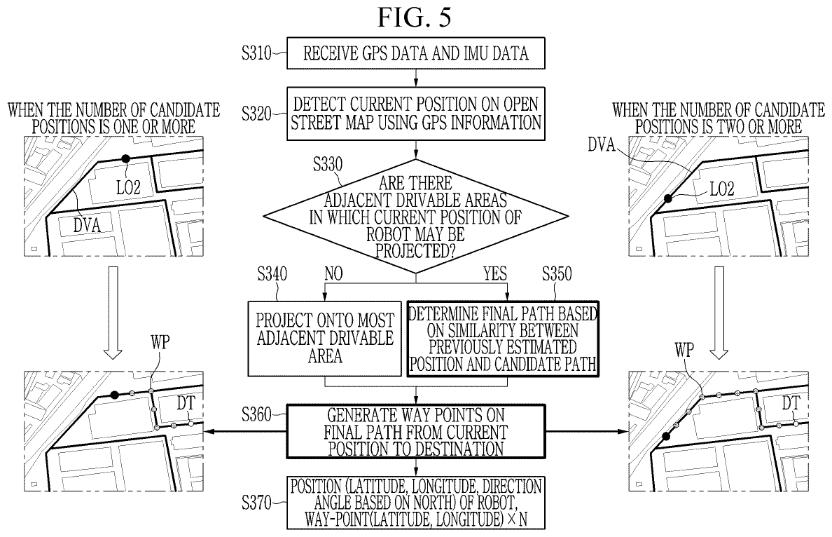

In FIGS. 4 and 5, the non-precision map-based driving guide apparatus 100 may determine the second position LO2 as the way point WP for the first position LO1.

In FIGS. 3 to 5, the non-precision map-based driving guide apparatus 100 may generate a plurality of way points WP on the final path from the current position to the destination DT (step S360).

The non-precision map-based driving guide apparatus 100 may determine the positions (latitude, longitude, direction angle based on north) of N robots to the destination, and way points (latitude, longitude) (step S370).

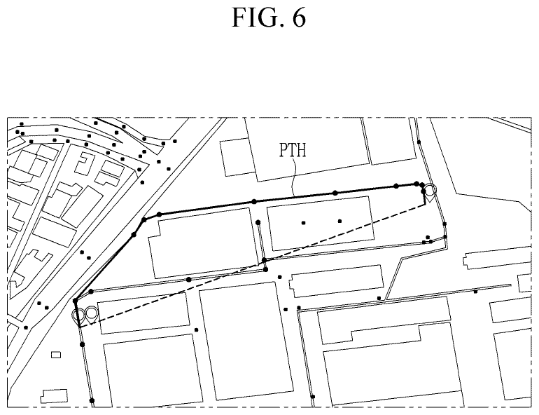

FIG. 6 is a diagram illustrating a generated current position and driving guidance including a way point acquired according to an embodiment of the present disclosure.

The non-precision map-based driving guide apparatus 100 calculates a similarity or path cost based on a GPS-based estimated position and determines a final path projected onto a drivable area, and determines a plurality of way points based on the determined final path.

The non-precision map-based driving guide apparatus 100 may provide a driving path PTH passing through a plurality of way points.

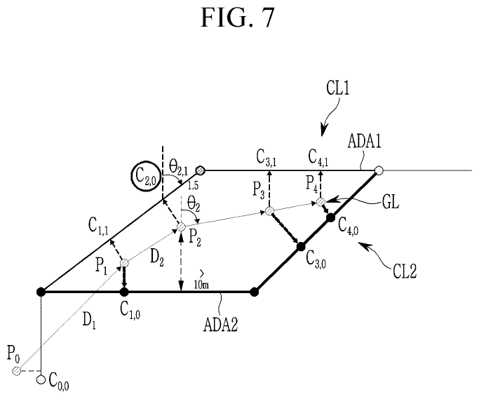

FIG. 7 is a diagram illustrating a candidate path according to an embodiment of the present disclosure. FIG. 7 illustrates candidate paths according to an example. There may be two or more candidate paths.

In FIG. 7, a first candidate path CL1 on the first adjacent drivable area ADA1 may include first candidate positions including C1,1, C2,0, C3,1, and C4,1.

A second driving path CL2 on the second drivable area ADA2 may include second candidate positions including C1,0, C3,0, and C4,0.

The past position GL, which is a previously estimated position, includes P1, P2, P3, and P4.

C2,0 may be excluded from the second adjacent drivable area ADA2 because it is more than 10 meters away from the past first position estimated based on the GPS. Therefore, C2,0 is not included in the second candidate positions.

The non-precision map-based driving guide apparatus 100 may finally select one of the first candidate position on the first candidate path CL1 passing through the adjacent drivable areas ADA1 and ADA2 or the second candidate position on the second candidate path CL2 based on the past position GL, and determine the second position by projecting the first position, which is the current position, onto the selected position.

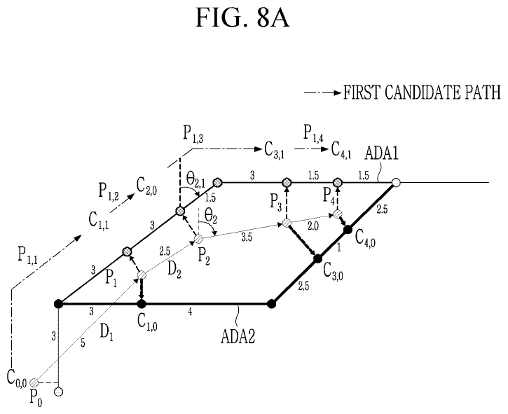

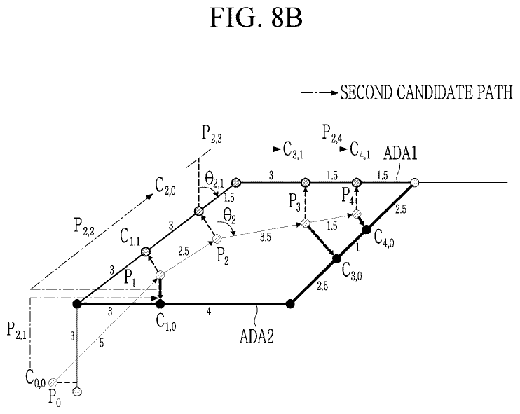

FIGS. 8A and 8B are diagrams for describing a method for calculating a path cost of each of candidate paths according to an exemplary embodiment of the present disclosure.

In FIG. 8A, the first candidate path is a path passing through the first adjacent drivable area ADA1. The first candidate path may include a plurality of first partial paths. The plurality of first partial paths may include P1,1, P1,2, P1,3, and P1,4. The plurality of first partial paths may be a plurality of sections on the candidate path.

P1,1 is a path from the starting position C0,0 to the first candidate position C1,1, P1,2 is a path from C1,1 to the second first candidate position C2,0, P1,3 is a path from C2,0 to C3,1, and P1,4 is a path from C3,1 to C4,1.

The non-precision map-based driving guide apparatus 100 may calculate the path cost based on the similarity between the past position and the first candidate path.

The past position includes P1, P2, P3, and P4. The first candidate path may include a plurality of first candidate positions including C1,1 corresponding to P1, C2,0 corresponding to P2, C3,1 corresponding to P3, and C4,1 corresponding to P4.

The non-precision map-based driving guide apparatus 100 may calculate the similarity or the path cost between first candidate positions each corresponding to the past positions.

The non-precision map-based driving guide apparatus 100 may calculate the path cost of the first candidate path using Equations 1 and 2 described in FIGS. 3 to 5.

The path cost (cost(path1)) of the first candidate path calculated through Equation 1 is calculated as follows.

$$cost ( path 1 ) = {\sum }_{t = 1} {d}_{t} = {d}_{1} + {d}_{2} + {d}_{3} + {d}_{4} = - 0.67661$$

Here, d₁, d₂, d₃, and d₄ are path costs of the first partial paths, respectively. The path cost of the first candidate path may be a sum of path costs of plurality of first partial paths.

d₁ may be the path cost of P1,1, d₂ may be the path cost of P1,2, d₃ may be the path cost of P1,3, and d₄ may be the path cost of P1,4.

d₁, d₂, d₃, and d₄ may be calculated as follows through Equation 2, respectively.

$${d}_{1} = \vert {‖ {P}_{0} - {P}_{1} ‖}_{2} - {‖ {C}_{0 , 0} - {C}_{1 , 1} ‖}_{route} \vert - cos ( Δ {θ}_{0} ) = \vert 5 - 6 \vert - cos ( 45 ) \approx 0.293$$

$${d}_{2} = \vert {‖ {P}_{1} - {P}_{2} ‖}_{2} - {‖ {C}_{1 , 1} - {C}_{2 , 0} ‖}_{route} \vert - cos ( Δ {θ}_{1} ) = \vert 2.5 - 3 \vert - cos ( 0 ) \approx - 0.5$$

$${d}_{3} = \vert {‖ {P}_{2} - {P}_{3} ‖}_{2} - {‖ {C}_{2 , 0} - {C}_{3 , 1} ‖}_{route} \vert - cos ( Δ {θ}_{2} ) = \vert 3.5 - 4.5 \vert - cos ( 10 ) \approx 0.01519$$

$${d}_{4} = \vert {‖ {P}_{3} - {P}_{4} ‖}_{2} - {‖ {C}_{3 , 1} - {C}_{4 , 1} ‖}_{route} \vert - cos ( Δ {θ}_{3} ) = \vert 2. - 1.5 \vert - cos ( 10 ) \approx - 0.4848$$

In FIG. 8B, the second candidate path is a path passing through the second adjacent drivable area ADA1. The second candidate path may include plurality of second partial paths. The plurality of second partial paths may include P2,1, P2,2, P2,3, and P2,4. The plurality of second partial paths may be a plurality of sections on the candidate path.

P2,1 is a path from the starting position C0,0 to the first second candidate position C1,0, P2,2 is a path from C1,0 to the second candidate position C2,0, P2,3 is a path from C2,0 to C3,1, and P2,4 is a path from C3,1 to C4,1.

The non-precision map-based driving guide apparatus 100 may calculate the path cost based on the similarity between the past position and the second candidate path.

The past position includes P1, P2, P3, and P4. The second candidate path may include a plurality of second candidate positions including C1,0 corresponding to P1, C2,0 corresponding to P2, C3,1 corresponding to P3, and C4,1 corresponding to P4.

The non-precision map-based driving guide apparatus 100 may calculate the similarity or the path cost between the second candidate positions each corresponding to the past positions.

The non-precision map-based driving guide apparatus 100 may calculate the path cost of the second candidate path using Equations 1 and 2 described in FIGS. 3 to 5.

The path cost (cost(path2)) of the second candidate path calculated through Equation 1 is calculated as follows.

$$cost ( path 2 ) = {\sum }_{t = 1} {d}_{t} = {d}_{1} + {d}_{2} + {d}_{3} + {d}_{4} = 5.61619$$

Here, d₁, d₂, d₃, and d₄ are path costs of the second partial paths, respectively. The path cost of the second candidate path may be a value that adds up the path costs of the plurality of second partial paths.

d₁ may be the path cost of P2,1, d₂ may be the path cost of P2,2, d₃ may be the path cost of P2,3, and d₄ may be the path cost of P2,4.

d₁, d₂, d₃, and d₄ may be calculated as follows through Equation 2, respectively.

$${d}_{1} = \vert {‖ {P}_{0} - {P}_{1} ‖}_{2} - {‖ {C}_{0 , 0} - {C}_{1 , 0} ‖}_{route} \vert - cos ( Δ {θ}_{0} ) = \vert 5 - 6 \vert - cos ( 45 ) \approx 0.293$$

$${d}_{2} = \vert {‖ {P}_{1} - {P}_{2} ‖}_{2} - {‖ {C}_{1 , 0} - {C}_{2 , 0} ‖}_{route} \vert - cos ( Δ {θ}_{1} ) = \vert 2.5 - 9 \vert - cos ( 45 ) \approx 5.7928$$

$${d}_{3} = \vert {‖ {P}_{2} - {P}_{3} ‖}_{2} - {‖ {C}_{2 , 0} - {C}_{3 , 1} ‖}_{route} \vert - cos ( Δ {θ}_{2} ) = \vert 3.5 - 4.5 \vert - cos ( 10 ) \approx 0.01519$$

$${d}_{4} = \vert {‖ {P}_{3} - {P}_{4} ‖}_{2} - {‖ {C}_{3 , 1} - {C}_{4 , 1} ‖}_{route} \vert - cos ( Δ {θ}_{3} ) = \vert 2. - 1.5 \vert - cos ( 10 ) \approx - 0.4848$$

Referring to FIGS. 8A and 8B, since cost(path 1)<cost(path 2), the non-precision map-based driving guide apparatus 100 may determine the first candidate path among the first candidate path and the second candidate path as the final path.

The non-precision map-based driving guide apparatus 100 may determine the second position by projecting the first position onto the first candidate path, and may determine the way point of the current position based on the second position.

FIG. 9 is a diagram for describing a computing device according to an exemplary embodiment of the present disclosure.

Referring to FIG. 9, the non-precision map-based driving guide apparatus and method according to exemplary embodiments may be implemented using a computing device 900.

The computing device 900 may include at least one of a processor 910, a memory 930, a user interface input device 940, a user interface output device 950, and a storage device 960 that communicate via a bus 920. The computing device 900 may also include a network interface 970 that is electrically connected to a network 90. The network interface 970 may transmit or receive signals to and from other entities through the network 90.

The processor 910 may be implemented in various types such as a micro controller unit (MCU), an application processor (AP), a central processing unit (CPU), a graphic processing unit (GPU), a neural processing unit (NPU), and may be any semiconductor device that executes instructions stored in the memory 930 or the storage device 960. The processor 910 may be configured to implement the functions and methods described above with reference to FIGS. 1 to 8.

The memory 930 and the storage device 960 may include various types of volatile or non-volatile storage media. For example, the memory may include a read only memory (ROM) 931 and a random access memory (RAM) 932. In an exemplary embodiment of the present disclosure, the memory 930 may be positioned inside or outside the processor 910, and the memory 930 may be connected to the processor 910 through various means that are well-known.

In some exemplary embodiments, at least some components or functions of the non-precision map-based driving guide apparatus and method according to the exemplary embodiments may be implemented as a program or software running on the computing device 900, and the program or software may be stored on a computer-readable medium.

In some exemplary embodiments, at least some components or functions of the non-precision map-based driving guide apparatus and method according to the exemplary embodiments are implemented using hardware or circuits of the computing device 900, or may be implemented as separate hardware or circuit that may be electrically connected to the computing device 900.

Although embodiments of the present disclosure have been described in detail hereinabove, the scope of the present disclosure is not limited thereto, but may include several modifications and alterations made by those skilled in the art to which the present disclosure pertains using a basic concept of the present disclosure as defined in the claims.

### DESCRIPTION OF SYMBOLS

10: Sensor unit
20: Driving guide unit
30: Robot control unit
100: Non-precision map-based driving guide apparatus
110: First position determination module
120: Second position determination module
130: Way point determination module

What is claimed is:

1. A non-precision map-based driving guide apparatus that estimates a current position based on global positioning system (GPS) information on a non-precision map without creating a precision map and determines a way point to a destination by executing a program code loaded on one or more memory devices through one or more processors,
wherein the program code is executed to perform:
determining a first position estimated as the current position of a robot on the non-precision map based on at least one of the GPS information and inertial measurement unit (IMU) information;
determining a second position by projecting the first position onto an adjacent drivable area using the GPS information; and
determining the second position as the way point for the first position.

2. The non-precision map-based driving guide apparatus of claim 1, wherein determining the second position as the way point for the first position includes:
determining a plurality of way points to the destination based on the first position and the second position, respectively.

3. The non-precision map-based driving guide apparatus of claim 1, wherein determining the first position estimated as the current position of the robot on the non-precision map based on at least one of the GPS information and the IMU information includes:
determining the first position using an open street map (OSM) as the non-precision map.

4. The non-precision map-based driving guide apparatus of claim 1, wherein determining the second position by projecting the first position onto the adjacent drivable area using the GPS information includes:
determining at least one drivable area that is less than a reference distance from the first position among a plurality of drivable areas on the non-precision map as the adjacent drivable area.

5. The non-precision map-based driving guide apparatus of claim 4, wherein determining the second position by projecting the first position onto the adjacent drivable area using the GPS information further includes, when there are a plurality of determined adjacent drivable areas:
calculating respective similarities with GPS-based past positions determined before the first position with respect to each of a first candidate path and a second candidate path defined in each of the plurality of determined adjacent drivable areas;
determining one of the first candidate path or the second candidate path as a final path based on the calculated respective similarities; and
determining the second position by projecting the first position onto the determined final path.

6. The non-precision map-based driving guide apparatus of claim 5, wherein calculating the respective similarities with the GPS-based past positions determined before the first position with respect to each of the first candidate path and the second candidate path defined in each of the plurality of determined adjacent drivable areas includes:
calculating a path cost of each of the first candidate path and the second candidate path using Equation 1,
$$cost ( path ) = {\sum }_{t = 1} {d}_{t} \qquad [ Equation 1 ]$$
in which, cost (path) is a path cost of the candidate path, dₜ is a path cost of a partial path on the candidate path at time t, and respective partial paths correspond to each of a plurality of sections on the candidate path.

7. The non-precision map-based driving guide apparatus of claim 6, wherein calculating the respective similarities with GPS-based past positions determined before the first position with respect to each of a first candidate position on the first candidate path and a second candidate position on the second candidate path defined in each of the plurality of determined adjacent drivable areas further includes:
calculating a respective partial path cost of each of a plurality of partial paths at time t using Equation 2,
$${d}_{t} = \vert {‖ {P}_{t - 1} - {P}_{t} ‖}_{2} - {‖ {C}_{t - 1 , i} - {C}_{t , j} ‖}_{route} \vert - \vert cos ( Δ {θ}_{t} ) \vert \qquad [ Equation 2 ]$$
$${Δθ}_{t} = {θ}_{t} - {θ}_{t , j}$$
in which, t is time, dₜ is the path cost of the partial path at time t, Pₜ is an estimated robot position at time t, C_{t,j} is a position of Pₜ projected onto an i-th drivable area, Δθₜ=θₜ−θ_{t,j} is an angular difference between an angle of a path and a robot position at time t, θₜ is an angle of P̅ₜ̅P̅ₜ̅₊̅₁̅ base on a true north, θ_{t,j} is an angle of an edge at C_{t,j} based on the true north, ∥C_{t-1,i}−C_{t,j}∥ᵣₒᵤₜₑ is a distance along the path, and ∥Pₜ₋₁−Pₜ∥₂ is a Euclidean distance.

8. The non-precision map-based driving guide apparatus of claim 7, wherein determining one of the first candidate path or the second candidate path as the final path based on the similarity includes:
determining a candidate path with a smaller path cost among the first candidate path and the second candidate path as the final path.

9. A non-precision map-based driving guide method performed by a computing device including a processor and a memory, the non-precision map-based driving guide method comprising:
determining, by the processor, a first position estimated as a current position of a robot on a non-precision map based on at least one of global positioning system (GPS) information and inertial measurement unit (IMU) information;
determining, by the processor, a second position by projecting the first position onto an adjacent drivable area using the GPS information; and
determining, by the processor, the second position as a way point for the first position.

10. The non-precision map-based driving guide method of claim 9, wherein determining the second position as the way point for the first position includes:
determining, by the processor, a plurality of way points to a destination based on the first position and the second position, respectively.

11. The non-precision map-based driving guide method of claim 9, wherein determining the first position estimated as the current position of the robot on the non-precision map based on at least one of the GPS information and the inertial measurement unit (IMU) information includes:
determining, by the processor, the first position using an open street map (OSM) as the non-precision map.

12. The non-precision map-based driving guide method of claim 9, wherein determining the second position by projecting the first position onto the adjacent drivable area using the GPS information includes:
determining, by the processor, at least one drivable area that is less than a reference distance from the first position among a plurality of drivable areas on the non-precision map as the adjacent drivable area.

13. The non-precision map-based driving guide method of claim 12, wherein determining the second position by projecting the first position onto the adjacent drivable area using the GPS information further includes, when there are a plurality of determined adjacent drivable areas:
calculating, by the processor, respective similarities with GPS-based past positions determined before the first position with respect to each of a first candidate path and a second candidate path defined in each of the plurality of determined adjacent drivable areas;
determining, by the processor, one of the first candidate path or the second candidate path as a final path based on the calculated respective similarities; and
determining, by the processor, the second position by projecting the first position onto the determined final path.

14. The non-precision map-based driving guide method of claim 13, wherein calculating the respective similarities with the GPS-based past positions determined before the first position with respect to each of the first candidate path and the second candidate path defined in each of the plurality of determined adjacent drivable areas includes:
calculating by the processor, a path cost of each of the first candidate path and the second candidate path using Equation 1,
$$cost ( path ) = {\sum }_{t = 1} {d}_{t} \qquad [ Equation 1 ]$$
in which, cost (path) is a path cost of the candidate path, dₜ is a path cost of a partial path on the candidate path at time t, and a partial path corresponds to each of a plurality of sections on the candidate path.

15. The non-precision map-based driving guide method of claim 14, wherein calculating the respective similarities with the GPS-based past positions determined before the first position with respect to each of the first candidate path and the second candidate path defined in each of the plurality of determined adjacent drivable areas further includes:
calculating, by the processor, respective partial path costs of each of a plurality of partial paths at time t using Equation 2,
$${d}_{t} = \vert {‖ {P}_{t - 1} - {P}_{t} ‖}_{2} - {‖ {C}_{t - 1 , i} - {C}_{t , j} ‖}_{route} \vert - \vert cos ( Δ {θ}_{t} ) \vert \qquad [ Equation 2 ]$$
$${Δθ}_{t} = {θ}_{t} - {θ}_{t , j}$$
in which, t is time, dₜ is the path cost of the partial path at time t, Pₜ is an estimated robot position at time t, C_{t,j} is the position of Pₜ projected onto an i-th drivable area, Δθₜ=θₜ−θ_{t,j} is an angular difference between an angle of a path and a robot position at time t, θₜ is an angle of P̅ₜ̅P̅ₜ̅₊̅₁̅ base on a true north, θ_{t,j} is an angle of an edge at C_{t,j} based on the true north, ∥C_{t-1,i}−C_{t,j}∥ᵣₒᵤₜₑ is a distance along the path, and ∥Pₜ₋₁−Pₜ∥₂ is a Euclidean distance.

16. The non-precision map-based driving guide method of claim 15, wherein:
the determining of one of the first candidate path or the second candidate path as the final path based on the similarity includes
determining, by the processor, a candidate path with a smaller path cost among the first candidate path and the second candidate path as the final path.

17. A non-precision map-based driving guide system, comprising:
a sensor unit that includes a global positioning system (GPS), Light Detection and Ranging (LiDAR), and a plurality of cameras;
a driving guide unit that receives a non-precision map, estimates a current position of a robot on the non-precision map based on sensor information received from the sensor unit, determines a way point to a destination, and generates a driving path plan based on the way point; and
a robot control unit that controls driving of the robot based on the driving path plan received from the driving guide unit.

18. The non-precision map-based driving guide system of claim 17, wherein the driving guide unit includes:
a non-precision map-based driving guide apparatus that estimates the current position of the robot based on GPS information on the non-precision map and determines the way point to the destination;
a drivable area detection apparatus that detects an area in which the robot drives and an area in which the robot does not drive, respectively, using the sensor information; and
a local goal determination apparatus that determines a short-term driving path among driving path plans from the current position to the destination as a local goal based on information on the current position, the way point, and a drivable area.

19. The non-precision map-based driving guide system of claim 18, wherein the non-precision map-based driving guide apparatus includes:
a first position determination module that determines a first position estimated as the current position of the robot on the non-precision map based on at least one of the GPS information and inertial measurement unit (IMU) information;
a second position determination module that determines a second position by projecting the first position onto an adjacent drivable area using the GPS information; and
a way point determination module that determines the second position as the way point for the first position.

20. The non-precision map-based driving guide system of claim 19, wherein the second position determination module, when there are a plurality of determined adjacent drivable areas:
calculates respective similarities with past positions determined before the first position with respect to each of a first candidate path and a second candidate path defined in each of the plurality of determined adjacent drivable areas,
determines one of the first candidate path or the second candidate path as a final path based on the calculated respective similarities, and
determines the second position by projecting the first position onto the determined final path.
